(19) United States
(12) Patent Application Publication
(10) Pub. No.: US 2004/0190020 A1
(43) Pub. Date: Sep. 30, 2004

(54) Method for printing digital image data onto light-sensitive material

(76) Inventors: Thomas Schuhrke, Munich (DE); Stefan Amann, Langenfeld (DE); Edgar Draber, Odenthal (DE)

Correspondence Address: MILDE & HOFFBERG, LLP, 10 BANK STREET, SUITE 460, WHITE PLAINS, NY, 10606, US

(21) Appl. No.: 10/768,667

(22) Filed: Jan. 30, 2004

(30) Foreign Application Priority Data
Mar. 28, 2003 (EP) 03100832.9

(51) Int. Cl. G06K 15/12; H04N 1/23; H04N 1/407; H04N 1/56

(52) U.S. Cl. 358/1.9; 358/406; 358/504; 358/302

(57) ABSTRACT

A method for printing digital image data onto light-sensitive material, such as photographic paper, is disclosed. The image data to be reproduced are received at a reader station, an exposure correction is applied to the image data in a computing station, and the exposure-corrected data are printed onto the light-sensitive material by means of a printer module. The image data are corrected during the exposure correction in a manner that is both specific for the type of light-sensitive material used as well as for the image data. A printing over-exposure may be compensated during image output by the combination of these two dependencies during correction of the image data.

### BACKGROUND OF THE INVENTION

The invention relates to a method for printing digital image data onto light-sensitive material, wherein the image data are received at a reader station, an exposure correction is applied to the image data in a computing station, and the exposure-corrected image data are output via a printing module onto the light-sensitive material.

Such methods are known in the technical field of photographic laboratories, and find application both in so-called “mini-labs” and in large-scale photographic laboratory equipment. Mini-labs are combined devices that generally include, along with a printer, a scanner to digitalize data from negative film, various other input stations for pure digital image data, a computing unit to correct the digital image data, and a developing unit to develop the exposed photographic paper. Large-scale photographic laboratory equipment, on the other hand, is comprised, as a rule, of individual devices, so that the printer represents a separate device from the scanner, large computer, and developing devices. The printers largely determine the printing speed and thus the throughput of prints to be created; the exposure process itself is comparable in both devices.

Digital image data received by the printer may originate from various sources. Exposure corrections are performed on these digital image data in order to make them compatible with the characteristics of the particular printer. During this process, gray-scale calibration is performed in which the digital image data are superimposed onto a calibration correction curve. This has the effect that image points, whose color values in all three colors R, G, B are equal, actually appear gray in the printed image. Further, this allows for the determination of the overall light density range, or the differential between minimum and maximum densities, so that the brightest image points appear white and the darkest points appear black.

Gray stages, i.e., test data that represent gray areas of various intensities, which are usually printed to determine the calibration correction curve, are measured using densitometers, and the values thus obtained are compared with nominal (i.e., desired) values. If, for example, a light red tint results from the measured test strip instead of a neutral gray, it is then determined for exposure correction that these are to be altered so that Red values are reduced with respect to those for Green and Blue. The gray-stage is corrected based on the newly-determined correction data, and is again printed. This new printing is again measured using a densitometer and compared with the nominal values. If the result after the correction is an improvement but not yet adequate, the cycle is repeated until a satisfactory gray-stage is achieved. The correction values that had to be applied in order to obtain the desired gray image are now stored and then subsequently applied to all digital image data to be printed for this combination of printer and light-sensitive material.

In spite of this exposure correction, it has been shown, however, that undesired artifacts may occur upon printing of, for example, fine white text against dark background. Thus, in the worst case, this text may appear as a washed-out gray-black area, and thus be totally illegible.

### SUMMARY OF THE INVENTION

It is therefore the principal object of the invention to provide a method for printing of digital image data in such a manner that the washout of image content during printing is prevented.

This object, as well as other objects which will become apparent from the discussion that follows, are achieved, in accordance with the present invention, by providing a printing correction method which includes a correction step that is both specific for the type of light-sensitive material used and for the image data.

According to the invention, the digital image data to be printed by the printer is subjected to correction before printing during which both image-data-specific and light-sensitive output material-specific correction data are used. Only the combination of image data-specific and paper-specific correction data leads to a suitable result. It has been shown that, particularly with laser printers, undesired washouts that occur when very dense image information is printed at the transitions to white image areas stem from over-exposure that particularly arises with specific types of paper. In such case, a density step is not reproduced during printing as a sharp edge, but rather the dense area is over-exposed, i.e., image content appearing dark in the print extends well into the neighboring bright area. Based on the invention, this phenomenon is handled in that the image data are so manipulated before printing that the overexposure is compensated. Before printing the image data, the approximate over-exposure anticipated is determined for pre-determined gray stages. The image data to be printed are then reduced by this anticipated over-exposure, or a portion thereof, at corresponding gray stages so that an approximate depiction of the original image data results from the sum of the corrected image data and over-exposure occurring during printing.

Since it has been determined that this over-exposure is dependent on the amount and absolute value of each density step within the image content at which it occurs, as well as on the characteristics of the light-sensitive material used, correction data are then determined that are dependent on image data and material. An advantage of this procedure is that the maximum black densities for the exposure may be so selected that actual black results in the printed image without over-exposures that are too strong.

A decrease in the maximum density would at least reduce the problem of over-exposure, but at a cost to the maximum black densities.

It is particularly advantageous to apply this over-exposure correction to the image data ready for output. The density stages that are actually responsible for the over-exposure are available only after the digital image data have passed through all image processing/correcting steps and are ready for output. Only a correction based on output-ready digital image data allows for prior calculation and the taking into account of actual defects. If, for example, one were to undertake the over-exposure correction in the course of, e.g., focus improvement, one would use density steps as reference values that would again be subsequently altered. This would considerably reduce computing expense, but might lead to degradation of the correction quality.

The over-exposure correction is advantageously performed individually for each image color. Image contents and thereby density variations might be completely different for Blue, for example, than for Red. This is taken into account via a color-specific over-exposure correction calculation.

High-resolution image data of the image to be corrected are preferably analyzed for determination of the over-exposure correction. A potentially advantageous form of analysis is an edge-recognition process. Density steps at which over-exposure might occur, and thereby at which a correction is to be performed, are determined based on this process. During this process, the position and height of density steps are advantageously maintained.

Another particularly advantageous, simple analytical method to determine the digital image data-specific correction data is the filtering of image data. For this, any suitable filters may be used. It is particularly advantageous, however, to use a two-dimensional filter in which density steps are taken into account both along the x-axis and the y-axis equally. The use of two-dimensional filters is, however, relatively computing-intensive, so that it may also be advantageous to filter sequentially and one-dimensionally first the x-axis and the y-axis in order to save capacity. This, however, may lead to problems at corner-angle points of edges within the image.

In an advantageous embodiment of the invention, a filter with a range of five image points is used. It is thereby also possible to correct over-exposures that extend across more than one image point outside the density step. More narrow filters would prove to be problematic for such wide over-exposures, whereas wider filters would require unnecessary computing capacity. Thus, a filter with five image points represents the optimum compromise. If, however, a large amount of computing capacity is available, an additional filter may be even more advantageous.

These image-specific correction data, which must be determined anew for each image to be corrected, must be combined with exposure-specific correction data that are dependent upon the printer and the light-sensitive material used. The latter changes each time with the selection of a new photographic paper, and should therefore preferably be re-determined as paper-specific correction data upon insertion of different paper into the output device. This preferably occurs based on a calibration process. During this, a prescribed test pattern is printed onto the light-sensitive material, and is measured using a densitometer after being developed. The test pattern is preferably so configured that it may be used as a standard for the over-exposure during printing. The values measured on the densitometer, which thereby specify the over-exposure, are input into the device, or transferred to the computing unit from a densitometer potentially internal to the device. The paper-specific correction data is formed for this current light-sensitive material within the computing unit.

Test patterns are advantageously used to determine the paper-specific correction values that include a large number of sequential density steps, or density jumps. Any variation of black/white or gray line patterns is suitable for this. It is important that density steps of varying magnitudes are represented in the test pattern, whereby each of these is ideally based on varying base values, since it has been shown that a different over-exposure may result even with density steps that are equally high if they lie within differing density areas.

Measurement of the exposed and developed test pattern may be performed using a micro-densitometer. These devices, however, are very expensive, so that it is more advantageous to position the test patterns so that over-exposure is possible based on an integral measurement of the exposed test pattern.

If the actual over-exposure occurring during the current exposure is known, then it may be compared with the maximum allowable over-exposure to be determined. From this comparison, paper-specific correction data result as a standard for by how much the measured over-exposure is to be reduced in order to achieve the maximum allowable, desired over-exposure. For this, it is advantageous to consider the over-exposure as a function of the density. It may, however, also be represented as a function of the density differential, or as a two-dimensional function dependent upon base density and density differential.

The correction may be performed particularly advantageously if paper-specific correction data are determined for each new type of light-sensitive material used. This may be achieved in that the operator of the printing device performs this calibration measure upon selection of a new type of paper. Determination of the paper-specific correction data may, however, be performed automatically within the printer. For this purpose, the printer includes a densitometer, or is connected with such, to which the exposed test strip is transferred automatically after developing. The data determined at the densitometer are automatically transferred to the printer, at which paper-specific correction data are determined from them.

A further advantageous possibility for determining the paper-specific correction data involves determining and storing these data upon placing the device into operation, at least for the most significant types of light-sensitive material at pre-determined maximum densities. In such case, the operator must merely enter the paper type, or it is recognized by the device, then the printer seeks the appropriate, pre-stored paper-specific correction data and performs the exposure correction based on these data. The advantage of this embodiment of the invention is that the operator need not perform calibration upon selection of a new paper type, but the disadvantage is that new paper types cannot thus be taken into account.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a schematic representation of a printer for digital image data.

FIG. 2, comprising FIGS. 2a, 2b, 2c and 2d, shows a schematic representation of a density step based on image data and the printed image, with and without corrections according to the invention.

FIG. 3 is a schematic representation of the density progression of a test pattern along one dimension.

FIG. 4 shows the dependence of over-exposure on density.

FIG. 5 shows the connection between uncorrected and corrected, output-ready image data.

FIG. 6 is a photographic paper-specific correction characteristic curve.

### DESCRIPTION OF THE PREFERRED EMBODIMENTS

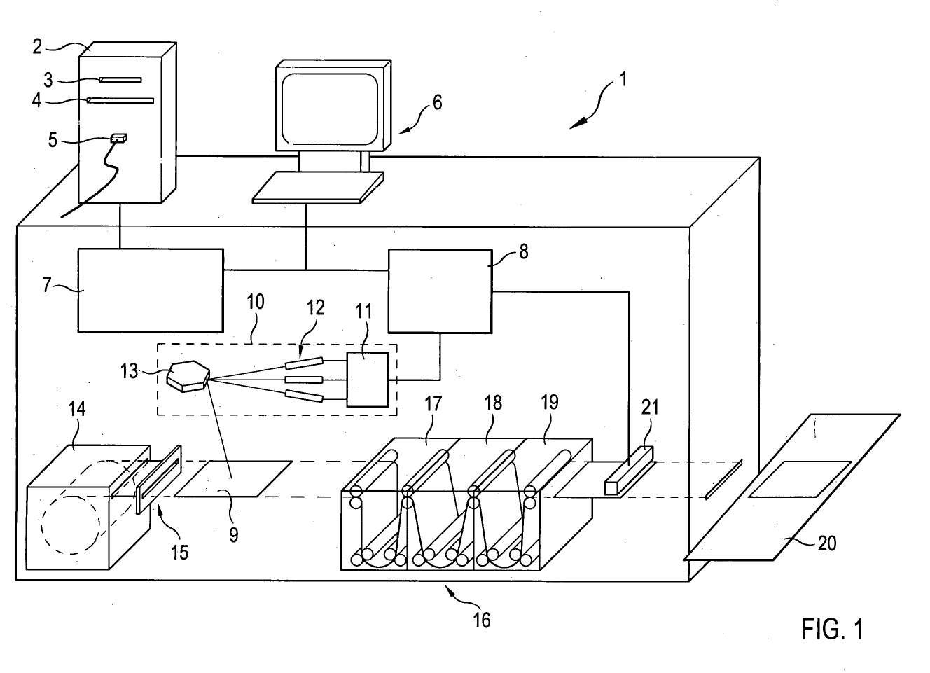

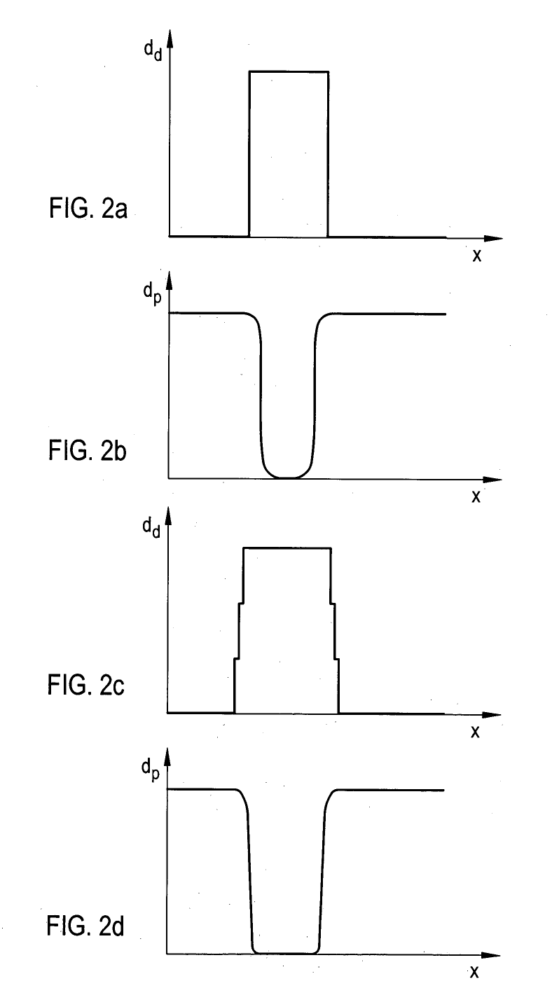

FIG. 1 shows schematically a printer 1 for printing digital image data onto light-sensitive material. The digital image data are received at a reader station 2. For this, the reader station includes a diskette drive 3, a CD-ROM drive 4, and a network connection 5. Additionally, other reader devices for digital storage media may be provided. Further, a film scanner may be integrated into the printer 1 by which negative film may be read in directly and its image information may be converted into digital image data. Customer and order-specific data are added to the image data received at the reader station 2 by means of a data input station 6 connected with the reader station 2. The image data received are passed together with the order data to a computing station 7, which may be a personal computer (PC). At the computing station 7, corrections are performed on the image data. Conventional, known image-data correction procedures in this context include focus correction, grain suppression, contrast corrections, edge drop-off corrections, and red-eye corrections, along with other known procedures to improve the image. The corrected data are passed to an additional computing station 8 in which corrections are performed that are characteristic for this printer as well as for the photographic paper 9 used. This printer correction ensures that the image data are optimized for the conditions reigning during the subsequent printing. It is, of course, possible for the computing stations 7 and 8 to be combined into one computer, or for the printer to be more simply structured, whereby the computing station 7 is obviated and the image data are essentially so output as they were received, whereby merely a printer correction occurs in the computing station 8. The method according to the invention is realized within the scope of printer correction that is performed in the computing station 8. This method is described in detail below in connection with FIGS. 2-6. The output-ready, corrected image data are passed on to a printing module 10, at which point they are printed onto the photographic paper 9. The printing module, in this case, includes a control unit 11 that serves to control the color lasers 12 for Red, Green, and Blue so that they emit light beams corresponding to the image data onto a polygon 13 by means of which the bundled light beams strike the light-sensitive material. Optical elements such as an F-Theta lens (not shown) are used to bundle the light beams. The photographic paper 9 available for exposure is withdrawn from a paper cassette 14 by which it is cut into sheets by means of a cutting device 15. For exposure, each of the photographic paper sheets is passed along a transport path by means of a transport unit (also not shown). This transport unit (not shown) transports the exposed photographic paper 9 after exposure into a developing station 16 at which the photographic paper 9 passes through a developer bath 17, stop bath 18, and fixer bath 19. After developing, the paper is dried by being passed through a dryer (also not shown) and subsequently output to a belt sorter 20.

As has already been mentioned, thin lines that are printed by such a printer may appear washed out, particularly with the use of certain photographic papers 9, so that fine text to be reproduced may become illegible. Therefore, based on the invention, an additional correction step is performed at the computing station 8 within the scope of printer correction during which characteristic paper-specific correction data are taken into account in combination with image-data-specific correction data, since it has been found that over-exposure is both dependent on the type of paper used as well as the image content to be printed. In order to determine paper-specific correction data, digital image data are stored in a storage buffer (not shown) for a test strip that is exposed and developed upon calibration of a new paper type to be used as a test print. After developing, the issued test strip is measured on a densitometer 21 integrated into the device. The over-exposure values thus determined are passed to the computing station 8 for printer correction, where they are used to calculate the paper-specific correction data. Desired maximum-permissible nominal values for the over-exposure are also stored in a buffer (not shown), or newly input at the data-entry station 6, which leads to a resulting image that allows superb reproduction, even for fine text or computer graphics with extreme dark/bright transitions.

FIG. 2, comprised of FIGS. 2a-2d, shows a density profile in each of four schematic representations in order to explain the method according to the invention. The first density characteristic, FIG. 2a, represents a density step within the densities of the image data d_{d} along an image direction x. This is an example of a density progression within the output-ready image data as they arrive from image processing in computing stations 7 and 8 in case no over-exposure correction was performed. The second characteristic, FIG. 2b, shows schematically how this progression of image data and density d_{d} appears after exposure as a paper density progression dₚ onto the light-sensitive material, or would be detectable by a micro-densitometer. A laser by means of which the image data are printed onto photographic paper, for example, is used here as the printer. An expansion of the sharp density edges within the digital image data occurs because of the properties of the printer (here, a laser whose emission possess a Gauss profile) and the photographic paper. The dark image area thereby intrudes into whites positioned between them (dₚ=0). If the white image area is very narrow and the over-exposure is very strong, it may occur in extreme cases that the completely over-exposed white area is overlapped by an area of higher densities. In this case, for example, a line pattern with narrow, white spaces between the lines becomes a black-gray area on the exposed print. Thin text would thus become illegible. This problem principally occurs in all known printers of digital image data such as, for example, LED, LCD, CMC, and laser printers, but the less the image points are sharp-edged, the worse it becomes. Further, it is dependent on the properties of the material to be exposed, Thus, there are photographic papers that show extremely strong over-exposure characteristics, while others avoid this problem altogether. The third characteristic, FIG. 2c, schematically shows a density step for corrected image data. Based on the invention, at density jumps at which an over-exposure is anticipated, that which is subsequently cut out from the edge to a certain degree before exposure is added to the exposure as over-exposure. The anticipated over-exposure defect is thus (based on previously-determined over-exposure characteristics of the printer and the density structure of the image data) determined in advance, and is included in calculation of the image data to be output. During the subsequent exposure, and after the correction, the density progression shown in FIG. 2d results on the photographic paper. Over-exposure of the image data further occurs at the density step since the image data were already reduced by the anticipated amount of expansion, and the original density progression results after printing. This in turn approximately corresponds to the image data to be output as is to be seen in FIG. 2a.

The correction data used to correct the anticipated over-exposure are composed of an image-specific and a paper-specific component. The image-specific portion of the correction data essentially describes position and scope of density steps within each color extract of the image data. A high-pass filter with a range of five image points is used for this image-specific correction data to determine these density steps. In order to keep the necessary computing capacity small, this is a one-dimensional filter that is first applied along the x-axis. Subsequently, the data filtered and corrected along the x-axis are filtered and corrected along the y-axis. The image-specific correction data determined in one dimension thus essentially correspond to the result of a high-pass filtering of the output-ready image data in the line direction. This filtering result may be added to a characteristic curve that allows the incorporation of non-linear effects in order to optimize the image-data-specific correction data.

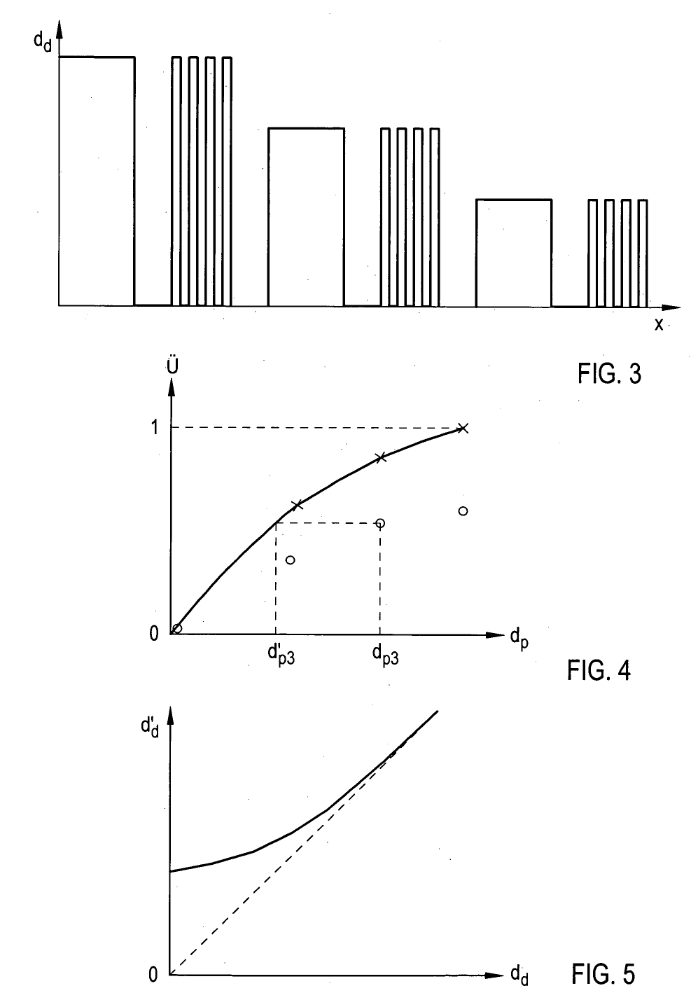

Determination of paper-specific correction data is accomplished by means of a test pattern that is printed onto photographic paper that is then developed and measured using a densitometer. An example for a suitable test pattern is shown in cross-section along the x-axis in FIG. 3. It includes full surfaces as reference values for density steps of varying heights. The density that would result upon printing of black areas over several image points onto photographic paper may be determined based on these data. The integral density may be derived from this that, for example, would then result if only half of all image points would have been black, and the other half would have been white. The integral density expected during this that serves as a reference value is maintained. Dark lines with the same density as the corresponding full surface are located on the test pattern to determine the over-exposure value. This line pattern consists of half dark and half white image points, so that half of the value of the surface would have to be determined as their integral density upon missing over-exposure. One must, however, take into account here that the white surface is not completely white, but rather that a certain minimum value must be determined for the paper ghost image, which minimum value must be derived both from the integral density value of the total surface as well as from that extracted from line pattern. If over-exposure occurs during exposure, then there is no white, but rather a gray tone, in the reproduced test pattern between the dark image points that increases the integral density. In order to maintain a standard for this over-exposure, the portion of the measured integral density of the total surface is formed as a reference that corresponds to that which the image data density of the line pattern has with respect to the total surface. If this agrees with the integral density determined for the line pattern, then no over-exposure occurred.

If, however, the measured integral density of the line pattern exceeds the reference value, then over-exposure occurred. At maximum over-exposure, the measured integral density of the line pattern corresponds in the worst case to the total integral density of the total surface. In this case, the lines in the exposed picture would be filled in.

The over-exposure values determined at the densitometer for the various density steps of the test pattern are interpolated so that an actual-value over-exposure characteristic curve results. This is shown in FIG. 4. Here, the crosses stand for the measured over-exposure values Ü which are applied to the paper density dₚ. Nominal values for acceptable over-exposure are determined as allowed correction. These are shown in FIG. 4, for example, as circles. A reproduction rule f is determined in order to determine the paper-specific correction characteristic curve that prints the nominal values onto the actual-value over-exposure characteristic curve. This function f depicts the density d on the corresponding nominal density d′. In FIG. 4, this is shown as an example of a density dₚₛ specified by a test pattern. The density d_{p3′} results from the fact that the nominal-value over-exposure of the density dₚ₃ is depicted on the actual-value over-exposure characteristic curve. Thus,

f(dₚ)=d_{p′}.

Since this assignment results with respect to the paper densities dₚ, but the correction at the printer must be undertaken on the densities of image data d_{d}, the determination of the assignment of paper densities dₚ to image-data densities d_{d} is necessary. This depiction rule

g(d_{d})=d_{p′}

is derived by means of an interpolation of the measured densities from the exposed test pattern as a characteristic curve. Thus, the nominal output density d_{p′} results from the expression

f(g(d_{d}))=d_{p′}

Finally, the function h is determined which to a certain extent assigns the image data densities d_{d′} to the output densities d_{p′} as the inverse of the function g. For function h, the following applies:

h(d_{p′})=d_{d′}

When one compiles all these determined depiction instructions, the expression

h(f(g(d_{d})))=d_{d′}

results, which is the over-exposure correction function that assigns the over-exposure-corrected densities d_{d′} to the output-ready data densities d_{d} to be corrected. This is shown in FIG. 5 as a characteristic curve.

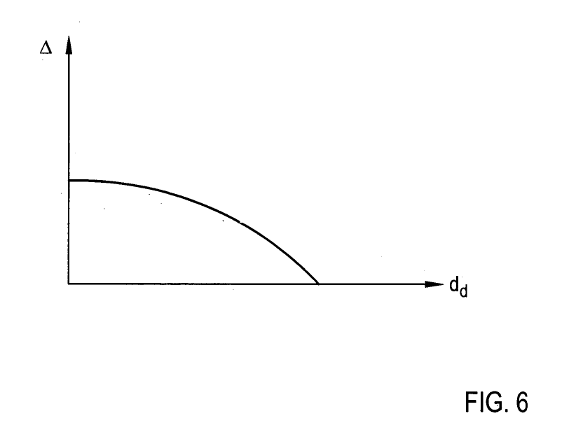

The paper-specific correction characteristic curve Δ results finally from the difference between d_{d} and d_{d′}. It is shown in FIG. 6, and shows the greatest correction at low densities of image data d_{d}, i.e., with large print densities dₚ.

Paper-specific correction characteristic curves and image-specific correction data—i.e., the result of the high-pass filtering—are compensated by each other for the over-exposure correction. The over-exposure-corrected, output-ready image data that are passed to the printer finally results from this.

An example of the calculation of the correction data was shown using a particular method. However, any number of other methods may be developed that determine the difference between over-exposure actual and nominal values based on pre-determined values and test patterns to be measured. Even the selection of test patterns offers many options.

There has thus been shown and described a novel method for printing digital image data onto light-sensitive material which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. In a method for printing digital image data onto light-sensitive material, wherein the image data are received at a reader station, an exposure correction is applied to the image data in a computing station, and the exposure-corrected image data are output via a printing module onto the light-sensitive material, the improvement wherein the exposure correction includes a correction step that is both specific for the type of light-sensitive material used and for the image data.

2. Method as defined in claim 1, wherein the correction step is applied to output-ready image data.

3. Method as defined in claim 1, wherein the correction step is applied to each color separately.

4. Method as defined in claim 1, wherein image-data-specific correction data are used for the correction step that are determined by analysis of the image data.

5. Method as defined in claim 4, wherein the image-data-specific correction data are determined by means of a method to detect edges within the image data.

6. Method as defined in claim 4, wherein the image-data-specific correction data are determined by means of filtering the image data.

7. Method as defined in claim 6, wherein a two-dimensional filter is used.

8. Method as defined in claim 6, wherein one-dimensional filters are used, and they are applied sequentially along the x-axis and the y-axis.

9. Method as defined in claim 6, wherein filters with a range of five image points are used.

10. Method as defined in claim 1, wherein paper-specific correction data based on the exposure and measurement of a test pattern are created, which serve as the standard for an over-exposure during printing.

11. Method as defined in claim 10, wherein the test pattern includes a large number of sequential density jumps.

12. Method as defined in claim 11, wherein over-exposure is determined from an integral measurement of the exposed test pattern.

13. Method as defined in claim 10, wherein the paper-specific correction data are derived from a correlation of measured and pre-specified maximum-allowable over-exposure.

14. Method as defined in claim 1, wherein paper-specific correction data are newly determined for each type of light-sensitive material used.

15. Method as defined in claim 1, wherein paper-specific correction data for specific types of light-sensitive materials are determined in advance and stored.
